(19) United States
(12) Patent Application Publication
(10) Pub. No.: US 2003/0139949 A1
(43) Pub. Date: Jul. 24, 2003

(54) Method, system and apparatus for managing multiple channels of travel services

(76) Inventors: Vajid Husain Jafri, Redwood Shores, CA (US); Christopher John Hanson, Palo Alto, CA (US); Vipin Kumar, Union City, CA (US); Sajid Husain Jafri, Foster City, CA (US)

Correspondence Address: ELLSWORTH R. ROSTON, ESQ., FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/052,763

(22) Filed: Jan. 18, 2002

(51) Int. Cl. G06F 17/60

(52) U.S. Cl. 705/5

(57) ABSTRACT

Upon a request from a travel agency, individual transactions (e.g. airline flights and fares) may be provided to a database at the travel agency through the internet from legacy and non-legacy airlines. Legacy airlines may be those within a global distribution system maintained by several of the leading airlines and non-legacy airlines may be those not within the global distribution system. A display screen at the travel agency's processing station displays the legacy transactions and the non-legacy transactions. The database selects one of the transactions and provides for the printing of a ticket for the selected transaction at a printer at the travel agency and for an accounting at the travel agency.

This is a continuation-in-part application of application Ser. No. ______ filed on Dec. 21, 2001, for a METHOD, SOFTWARE PRODUCT, SYSTEM AND APPARATUS FOR MANAGING MULTIPLE CHANNELS OF TRAVEL SERVICES and listing Vajid Husain Jafri, Christopher Hohn Hanson, Vipin Kumar and Sajid Husain Jafri as joint inventors and assigned of record to the assignee of record of this application.

This invention relates to services and accounting within the retail and wholesale travel services industries. This invention further relates to a system and a method for gathering offers of travel services from each of multiple travel service suppliers and their agents.

### BACKGROUND OF A PREFERRED EMBODIMENT OF THE INVENTION

The primary airlines (e.g. American, United and Delta) have handled bookings for their flights on legacy servers which have been identified by the trademarks “Sabre®”, “Galileo®”, “Amadeus®” and “Worldspan®”. The primary airlines provide established and published flight schedules and fares for their flights in these legacy servers. The legacy servers transmit these airline flights and fares through a wide area network to processing stations (e.g. travel agencies). Travel agents at the travel agencies obtain flight and fare information for their clients at processing stations at the travel agencies. The travel agents receive commissions when they book flights through the legacy servers. However, recently the primary airlines providing flight and fare information to the legacy computers have reduced the amount of the commissions paid to travel agents when the travel agents book the flights.

A number of airlines are not in the legacy servers. They include Southwest Airlines and America West Airlines. Tickets on these airlines can be obtained by telephone calls either from the travel agent or the client. Furthermore, the airlines provide for purchases of tickets on the internet through Orbitz®. Orbitz offers tickets at reduced prices. These reduced prices are below the established and published prices which are provided in the legacy servers of the primary carriers, but these discounts are generally only for flights in the near future and are often at the least desirable hours, such as late at night. Consolidators also purchase blocks of tickets from the airlines at wholesale prices and offer theses tickets through telephone lines to passengers generally at prices above the wholesale prices but below the retail price established and published by the airlines.

As will be seen from the above discussion, there are a number of different ways for a passenger to purchase airplane tickets. Some of these are at established and published retail prices. Others of these are at discounted prices. Some of these are available to travel agents and others are not. It would be desirable for travel agents to be accessible to all of these different ways of purchasing airline tickets. It would also be desirable for the travel agents to be able to offer to a client, with a minimal amount of effort, the optimal travel time for the client on a specified date at the lowest price on an airline acceptable to the client to travel from a specific originating location to a specific destination.

The following is the “Background” from the parent application:

The commercial sector of the Web has been extensively used for direct sales of travel services. At the consumer or end-user level, systems and methods for conducting e-commerce typically involve a computer running a web browser for accessing web pages from remote servers via the one and only, well-known, Internet. Computerized travel booking services, especially for air travel have become more complex with the rise in popularity of the Internet. Not only are there many more sources of services but terms and conditions are increasingly complex. A need to manage the various complexities on a single client computer exists. Sales and ancillary sales support activity (such as ticketing) within the travel industry is typified or dominated by an airline component. Thus the airline component services of the travel industry is paradigmatically used and envisioned in accompanying diagrams. A small number of online services provide a large proportion of air travel fare quotations and ordering for air travel booked by travel agents for clients. There are four such online services; they are known by their trade names, Sabre®, Worldspan®, Galileo®, and Amadeus®. These are collectively and individually known, in the art, as GDS (global distribution system(s)).

An important reason that travel agents use GDS is that they provide familiar bookkeeping arrangements, credit, ticketing, refunds and other terms and conditions. Especially, GDS generate accounting records for computerized billing systems and reports including statistics for clients. Such report keeping is of great importance to business and corporate clients.

However, the Internet and World Wide Web (“the Web”) have become everyday utilities for many businesses and individuals and often provide cheaper tickets than are available through GDS's. Under price performance pressure travel agents scan the world wide web for better prices and then purchase tickets over the Internet. The travel agent must then typically enter the purchase into a GDS in order to generate the required accounting records. Often, too, a service charge (profit margin) must be charged separately, rather than a preferred method of bundling or commissions from the supplier. Another problem is that Internet sales can often have complex and unfamiliar terms and conditions with the risk that the agent may purchase a non-refundable fare only to later notice a restriction that makes the fare useless to the client. Since the terms are not presented in a standard way, they are open to misinterpretation. Also, the agent may need authorization to advance credit (usually credit card credit) for the purchase. This can result in a dilemma for the business owner as to how much authority to spend money should be given to the agent since each situation is unique. Thus, the Internet is not as travel agent friendly as the GDS. However, sometimes travel agents must use the Internet to access websites or lose business. Websites are well known in the art.

### BRIEF DESCRIPTION OF A PREFERRED EMBODIMENT OF THE INVENTION

Upon a request from a travel agency, individual transactions (e.g. airline flights and fares) may be provided to a database at the travel agency through the internet from legacy and non-legacy airlines. Legacy airlines may be those within a global distribution system maintained by several of the leading airlines and the non-legacy airlines may be those not within the global distribution system. A display screen at the travel agency displays the legacy transactions and the non-legacy transactions. The database selects one of the transactions and provides for the printing of a ticket for the selected transaction at a printer at the travel agency and for an accounting at the travel agency.

The following constitutes the “Summary” of the invention from the parent application:

According to a first aspect of the invention, a method of presenting offers of travel services is disclosed. The method may include providing a client computer having a human interface, inputting requests for details of travel services, sending requests to a GDS and to a server computer, translating the request into web requests, sending web requests to websites and receiving responses therefrom, and displaying responses from the websites and from the GDS on a single display screen. According to a further aspect of the invention, software is provided to implement the method of the first aspect. According to a still further aspect of the invention, computers are provided to implement the method of the first aspect.

These and other features and advantages of the invention are set forth in part in the description which follows and in part will become apparent to those having ordinary skill in the art upon examination of the following or may be learned from practice of the invention. The advantages of the invention may be realized and attained as particularly pointed out in the appended claims. The embodiments described should be viewed as exemplary and enabling and disclosing best know mode rather than limiting as to the bounds of the invention.

### BRIEF DESCRIPTION OF THE DRAWINGS

In the drawings:

FIG. 1 shows a high level depiction of one embodiment of the invention;

FIG. 2 shows a high level depiction of a travel agency client computer network according to an embodiment of the invention;

FIG. 3 schematically represents a client computer used in an embodiment of the invention;

FIG. 4 schematically represents a server computer such as may be used to implement embodiments of the invention;

FIG. 5 shows a client computer display screen layout such as may be used in one embodiment of the invention;

FIG. 6 shows a flow diagram of reservation functions according to an embodiment of the invention;

FIG. 7 shows a flow diagram of accounting functions according to an embodiment of the invention;

FIG. 8 is a schematic diagram showing in block form a system of the prior art for providing air flight and air fare information for global distribution systems (Sabre®, Worldspan®, Galileo®, and Amadeus®), major hotel chains and major car rental companies;

FIG. 9 is a schematic diagram showing in block form a system of the prior art for providing air flight and air fares for the airlines other than those shown in FIG. 7, for the car rental agencies other than those shown in FIG. 7, for the wholesale inventory of the airlines and for tour operators; and

FIG. 10 is a schematic diagram showing in block form a system constituting a preferred embodiment of applicants' invention and providing for information relating to flight and fare information from the airlines, hotel chains, car rental companies and cruise line companies to be provided through the internet to a processing station at a travel agency.

### DETAILED DESCRIPTION OF A PREFERRED EMBODIMENT OF THE INVENTION

The following is the “Detailed Description” from the parent application:

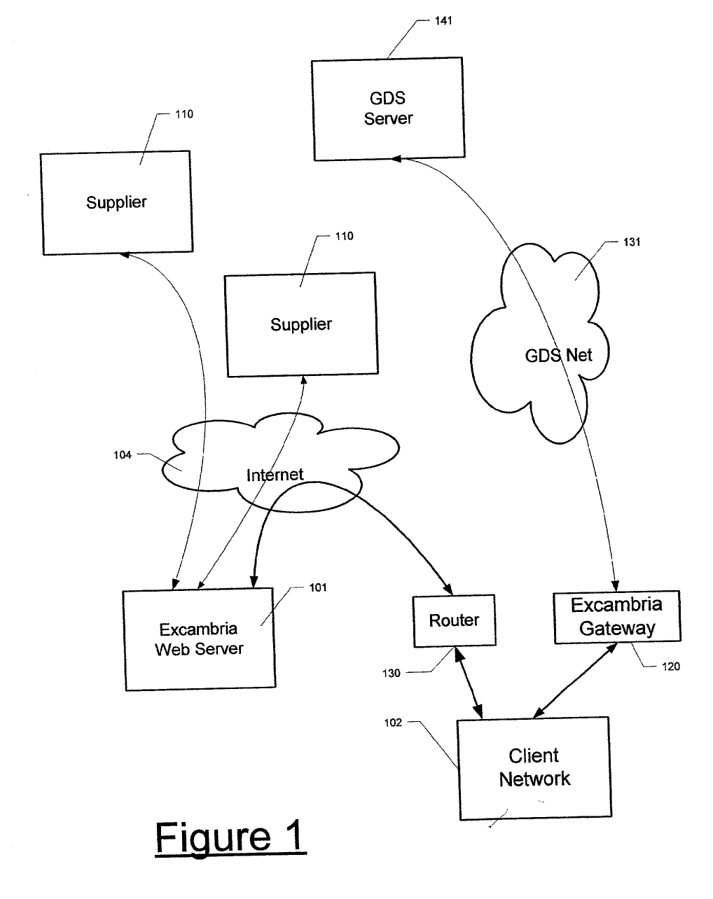

Consumer computer systems and methods are well known in the relevant arts. A high level depiction of one embodiment of this invention is shown in FIG. 1. Box 101 relates to one or more distributed processing servers which are well understood in the art. One particular such server that has been used to embody the invention is the Excambria™ Web Server 101 which is used as an example herein. The Figure depicts a travel agency client computer network 102 which may contain computer workstations (not shown in FIG. 1) that may connect though a router 130 and the Internet 104 to Excambria web server 101. The well known Internet Protocol (IP) is used to communicate over the Internet which is also well known in the art. Excambria™ Web Server 101 in turn connects via Internet 104 to multiple supplier server computers 110 (two shown, but typically many available). Supplier computers may typically operate as e-commerce websites, exchanging requests and responses by means of Internet oriented protocols such as FTP, HTTP, HTML, XML and/or many others. Travel agency client computer network 102 also connects through a Gateway 120 through a proprietary GDS telecommunication networks 131 to one of the several GDS 141 that may be available and which are typically based on mainframe computers. Presently there are four GDS in total and they are well known in the art.

Again referring to FIG. 1, examples of entities that may constitute server machines (box 101) are remote servers, auction servers, transaction servers, inventory systems, supplier managed systems, etc. Parts of the invention may incorporate (have parts that are implemented on) one or more of these example entities. The invention may also incorporate entities that are not listed herein. These entities cooperate with each other in gathering, transmitting, requesting, manipulating, etc. . . . travel related service information. The Internet Protocol (IP) is used for communication over the Internet (box 104) as is well understood in the art.

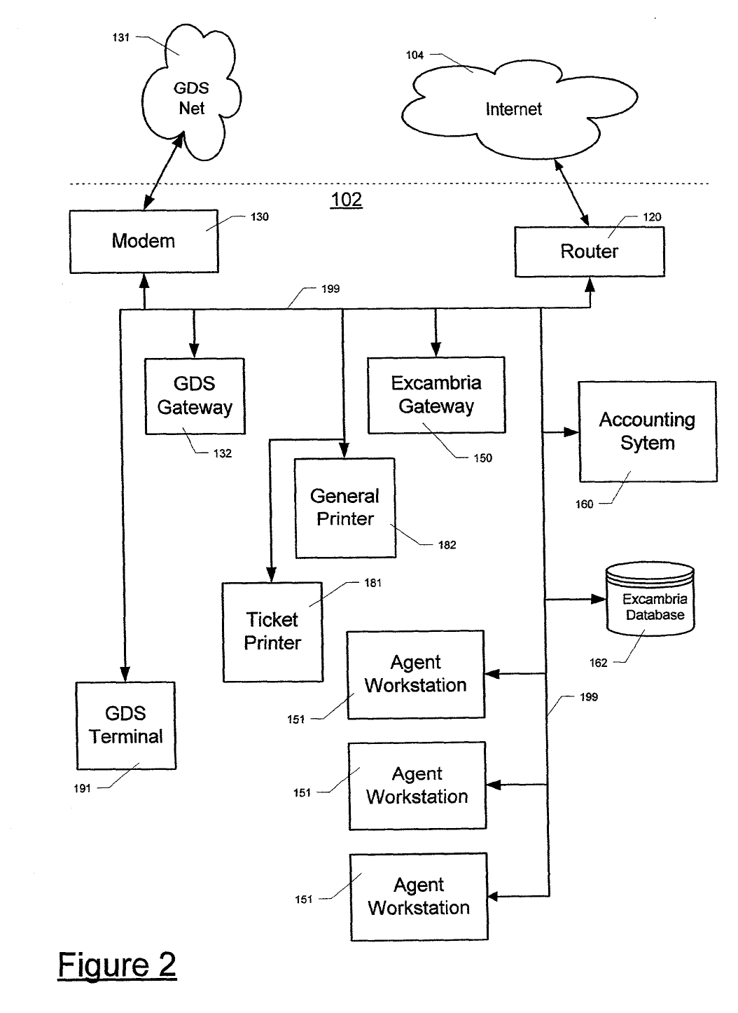

These and other features and advantages may be accomplished by the provision of alternative topologies of computer systems incorporating client computer(s), Internet server computers and GDS. FIG. 2 shows a high level depiction of a travel agency client computer network 102 according to an embodiment of the invention. The exemplary travel agency client computer network 102 may function as depicted in FIG. 1. Still referring to FIG. 2, the travel agency client computer network 102 connects to Internet 104 and GDS proprietary network 131. Gateway 130 connects GDS network 131 and Route 120 connects Internet 104. GDS network 131 provides communication to and from a GDS (not shown in FIG. 2) and Internet 104 provides communication to and from an Excambria server (also not shown in FIG. 2). Various intelligent devices within the travel agency client computer network 102 interconnect, for example, by means of a LAN (local area network) 199 which may be Ethernet, Token Ring or other LAN technology. Optional GDS terminal 191 may be a retained or “legacy” device that may be used by travel agents to access GDS, for example, outside the context of the invention. GDS Gateway 132 operates on behalf of GDS terminal 191 to forward requests and responses to GDS network 131 via modem 130.

One or more agent workstations 151 are provided for individual use by travel agents; typically such workstations may be implemented as software and hardware based upon the ubiquitous PC (Personal Computer). Agent workstations 151 communicate via Excambria gateway 150, LAN 199, Router 120 and Internet 104 with Excambria web server computer (not shown in FIG. 2). Excambria gateway 150 operates on behalf of agent workstations 151 to forward requests and responses to GDS network 131 via modem 130. The accounting system computer 160 may receive messages from many sources and maintains accounting records on an accounting database (not shown). The agent workstations 151 are typically client computers (PC) that implement Excambria client programs. Agent workstations 151 may be referred to, for convenience, as communicating with a GDS, but the Excambria gateway 150 receives requests and responses and forwards them to GDS from agent workstation or vice versa.

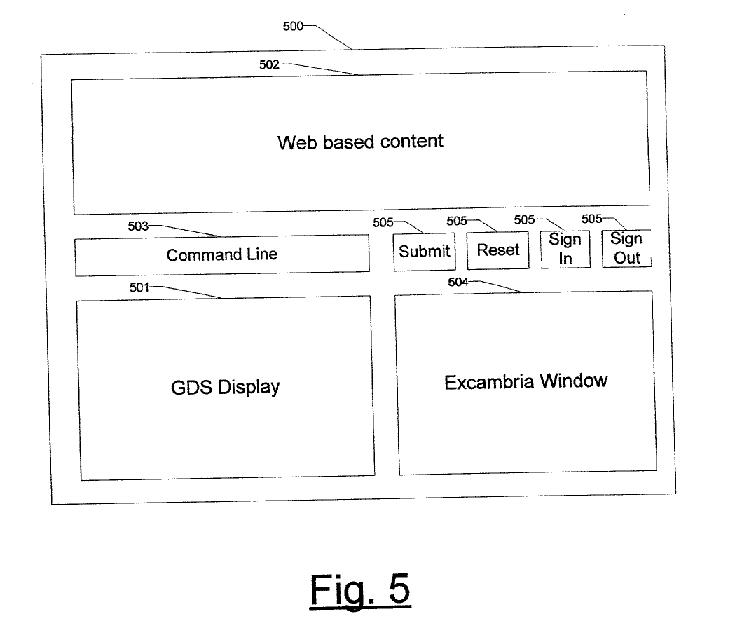

FIG. 5 shows an exemplary client computer display screen 500 layout such as may be used in one embodiment of the invention. The display screen 500 is divided into area or window 501, 502, 503, 504 and perhaps others. In one embodiment, the large area GDS Display window 501 provides a character-oriented scrolling window as may be required by GDS for the traditional human/compute interface thereto. Thus, a terminal emulation of a real GDS terminal optionally including features such as synchronous protocol may be performed using display window 501 and a client computer keyboard. The itinerary may be captured by filtering and interpreting a GDS formatted inquiry using command line 503 in the client computer or in an Excambria gateway or alternatively the itinerary may be entered directly using the human interface (e.g. keyboard) into command line 503. Various command “buttons” 505 for functions may be provided in accordance with the well known computer windows human interface. Window 502 may be used to display information such as inventory and pricing for itineraries located by an Excambria web server (and other web-based content) as is discussed below.

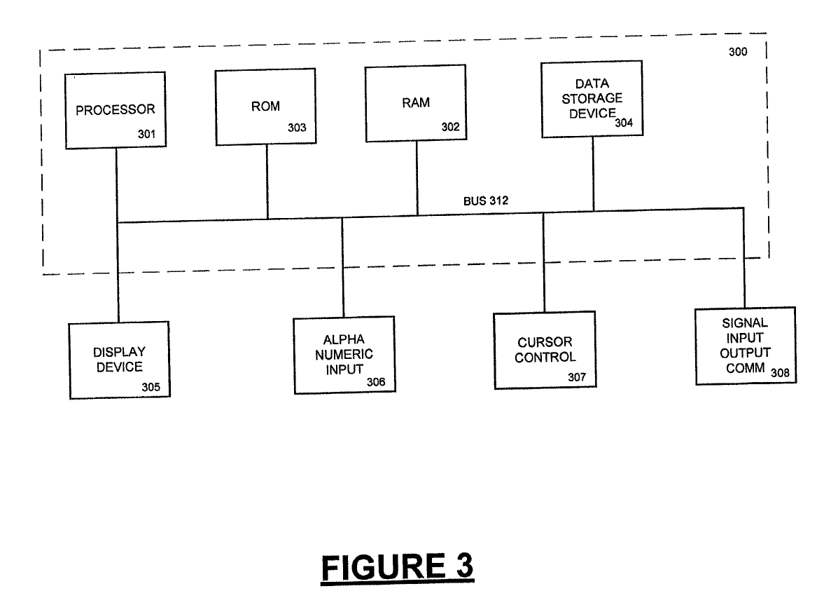

Reference is made to FIG. 3 illustrating a block diagram of a typical client computer system 300 which may be implemented or practiced by using the present invention. Such a client computer system may serve as the client computer system 102 of FIG. 1. Referring again to FIG. 3, client computer system 300 is connected to the Internet (not shown expressly, but typically via data communications port 308, sometimes known as an “I/O interface”). It is to be appreciated that client computer system 300 is exemplary only and that the present invention can operate within a number of different computer systems including general purpose computer systems, embedded computer systems, and others. In the following discussions of the present invention, certain processes and steps are realized as a series of instructs (e.g., software program) that reside within computer readable memory units of system 300 and executed by processors of system 300.

In general, client computer system 300 used by the present invention comprises address/data bus 312 for conveying information and instructions, central processor (CPU) 301 coupled with bus 312 for processing information and instructions, a random access memory (RAM) 302 for storing digital information and instructions, a read only memory (ROM) 303 for storing information and instructions of a more permanent nature. In addition, client computer system 300 may also include a data storage device 304 (e.g., a magnetic, optical, floppy, tape drive, etc.) for storing vast amounts of data, and an I/O interface 308 for interfacing with peripheral devices (e.g. computer network, modem, etc.). More particularly, the memories (e.g., RAM 302, ROM 303, and data storage device 304) of client computer 300 store the instruction codes in accordance with the present invention. A person of ordinary skill in the art will understand that the memories may also contain additional information such as applications programs, network communications programs (e.g., TCP/IP protocol), operating system software, data, etc.

Moreover, client computer system 300 may include a display device 305 for displaying information to a computer user, an alphanumeric input device 306 (e.g., keyboard), and a cursor control device 307 (e.g., mouse, track-ball, light-pen, etc.) for communicating user input information and command selections. This human oriented input and output features may be collectively used as the human interface.

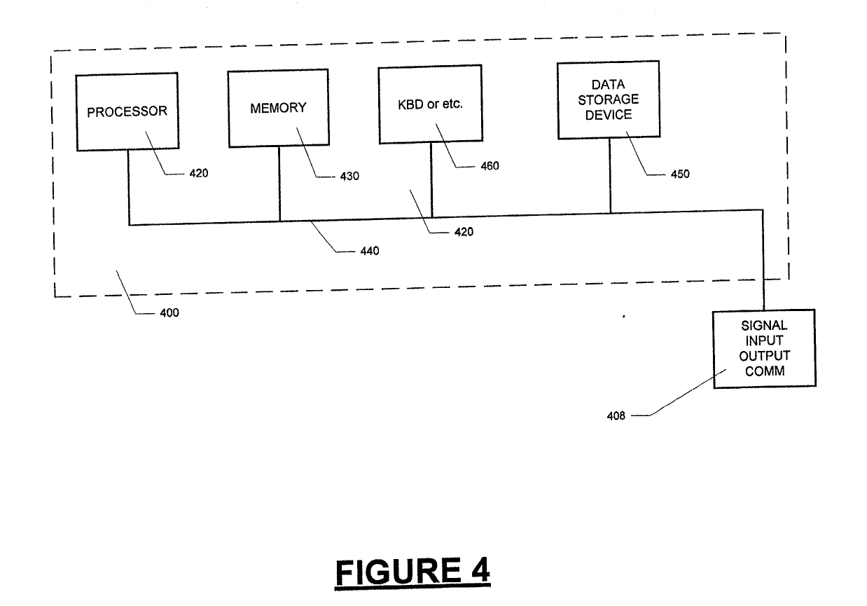

Referring to FIG. 4, server computer 400 comprises central processing CPU 420, memory 430, and communications adapter 408 which are connected together by system bus 440. Such a server computer system may serve as the Excambria server computer system 101 of FIG. 1. Memory 430 stores software. It will be understood by a person of ordinary skill in the art that server computer 400 can also include other elements not shown in FIG. 4 such as disk drives 450, keyboard 460, etc. A person of ordinary skill in the art will understand that memory 430 may also contain additional information such as applications programs, network communication programs (e.g., TCP/IP protocol stack), operating system software, data, etc. Client computer 300 and server computer 400 are linked together by a network, typically the Internet. Furthermore, a person of ordinary skill in the art will understand that the computer systems 300 and 400 may contain more or less than what is shown in FIGS. 3 and 4.

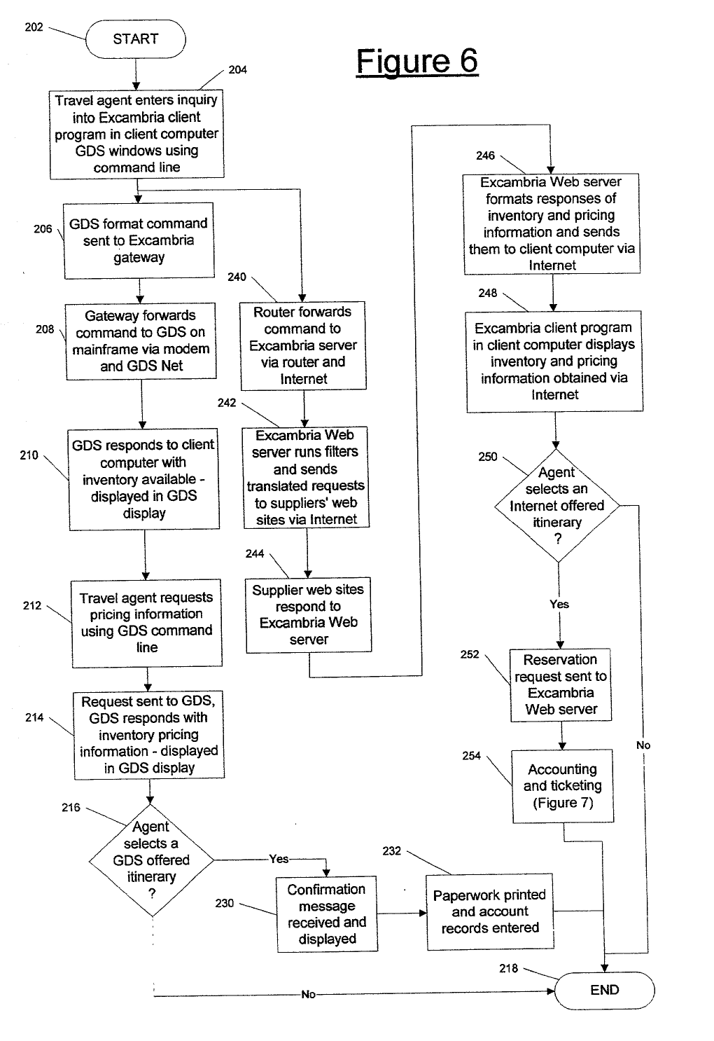

Reference is now made to FIG. 6 illustrating a flow diagram of a reservation method according to an embodiment of the invention. The Figure effectively shows the computer implemented acts to carry out part of the embodiment of the present invention. In general, the acts in FIG. 6 are designed to implement travel agent service mechanisms. The acts in FIG. 6 are carried out when processors 3-1 and 420 (FIGS. 3 and 4) execute the instruction codes stored in the memory of computer systems 300 and 400 (FIGS. 3 and 4). Websites and GDS, as are well known in the art, may also perform some of the necessary functions. It is to be appreciated that the acts described herein are illustrative only and other sequences of steps could be used within the general scope of the invention.

Still referring to FIG. 6, in box 202 the method is stated. In box 204, the travel agent enters an inquiry, such as for flight availability and/or pricing. The travel agent enters the inquiry into Excambria client program in client computer command line window using a command line format. A traditional concise GDS format is used, for example command such as “ALAXSFO22NOV” might be used to inquire as to the availability of airline ticket for travel from Los Angeles to San Francisco on November 22nd next. The client computer software may express the inquiry as a command upon the screen. Then in box 206, the client computer software forwards the GDS format command to Excambria gateway. The gateway may be a separate computer (as shown in FIG. 2) or it could be a physical or logical subsystem of the client computer itself. In box 208 the Gateway forwards command to GDS on mainframe via modem and the GDS Net. In box 210 the GDS responds to client computer (typically via the gateway) with inventory available which is displayed in the GDS display window. In box 212 the travel agent requests pricing information using GDS command line format. In box 214, the request is sent to GDS; GDS responds with inventory pricing information which is displayed in GDS display window of Excambria client program in client computer. In box 216, the travel agent decides whether to select a GDS offered itinerary. If not, the GDS based part of the method ends in box 218. Otherwise, in box 230, the GDS itinerary is selected and a confirmation message received and displayed by old GDS based procedures. In box 232 paperwork is printed and account records entered as for old GDS systems.

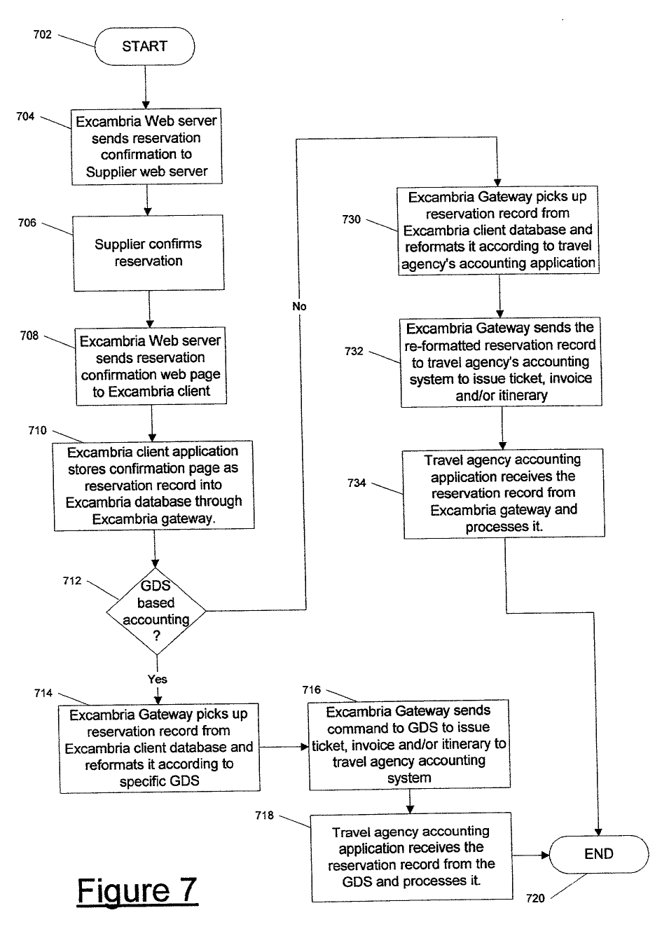

Meanwhile, in box 240, the router forwards a command to Excambria web server via router and Internet. In Box 242, the Excambria Web server runs filters and sends translated requests to suppliers' web sites via the Internet. In box 244, the suppliers' web sites respond to the Excambria Web server. Then, in box 246, the Excambria Web server formats responses of inventory and pricing information and sends them to client computer via the Internet. In box 248, the Excambria client program in the client computer displays inventory and pricing information obtained via the Internet. Then in box 250, the travel agent decides whether to select an Internet offered itinerary. If not, then the web based part of the method ends in box 218. Otherwise, in box 252, a reservation request is sent to Excambria Web server and, in box 254, accounting and ticketing may take place as described below in connection with FIG. 7.

It should be appreciated that, as may be required, the Excambria Web server may translate commands into various forms as may be responded to by the web site of travel service suppliers such as airlines, consolidators, tours operators or the like. Thus, the Excambria server maintains a dialog with various travel sites by sending web formatted commands according to the temporal needs of the many client computers at various locations. In the example given, a request for travel information between Los Angeles and San Francisco would not generate a web site inquiry to the website of British airways since they do not offer US domestic travel. On the other hand, inquiries may be sent to the web sites of the dozen or so airlines that do offer LAX SFO ticketing. If the agent is dissatisfied with all the itineraries offered-or if indeed there are not offers for reason of no availability, the agent may terminate the procedure and start again with, for example, a revised travel date after possible consultation with the prospective traveler. In addition to the functions described in connection with FIG. 6, embodiments of the invention may provide for capturing accounting data for travel services booked via the Excambria Web server. One expanded example of the functions of box 254 according to one embodiment of the invention is shown in FIG. 7. FIG. 7 shows a flow diagram of accounting functions according to an embodiment of the invention. In box 702, the method starts. In box 704, the Excambria Web server sends a reservation confirmation to a supplier web server via the Internet. In box 706, the supplier confirms the reservation. In box 708, the Excambria Web server sends a reservation confirmation web page to the Excambria client program in the client computer. In box 710 the Excambria client application program stores the confirmation page as a reservation record into an Excambria database via the Excambria Gateway. In box 712 a decision is made as to whether GDS based accounting is to be used. If so, in box 714, the Excambria Gateway picks up reservation record from Excambria client database and reformats it according to specific GDS. Then in box 716, the Excambria Gateway sends a command to GDS to issue ticket, invoice and/or itinerary to the travel agency accounting system. In box 718, the travel agency accounting application receives the reservation record from the GDS and processes it and the method ends in box 720.

If GDS based accounting is not to be used, then in box 730 the Excambria Gateway picks up the reservation record from the Excambria client database and reformats it according to the travel agency's accounting application. In box 732, the Excambria Gateway sends the re-formatted reservation record to the travel agency's accounting system to issue ticket, invoice and/or itinerary. In box 734, the travel agency's accounting application receives the reservation record from the Excambria Gateway and processes it and the method ends.

Many other embodiments of accounting functions are feasible within the general scope of the invention. The foregoing embodiments are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those of ordinary skill in the art.

The following is the “Detailed Description of Preferred Embodiment of the Invention” which is being added in this application:

FIG. 8 is a simplified block diagram, generally indicated at 800, of a system of the prior art. The system 800 provides established and published information relating to fares from a number of major airlines 802 (e.g. American, United and Delta) relating to airplane flights and fares. It also includes room availability and room rates from a number of major hotel chains 804 and it further includes information relating to car availability and car rental rates from a number of the major car rental companies 806.

The information from the major airlines 802, the major hotel chains 804 and the major care rental companies 806 are introduced to a global distribution system (GDS) 808 which may be a legacy server. Global distribution systems now in use include Sabre, Galileo, Amadeus and Worldspan. The information from the global distribution system 808 is provided through a wide area network 810 to processing stations such as travel agencies (including a travel agency generally indicated at 812). The travel agency 812 includes a number of substantially identical processing stations, one of which is generally indicated at 814.

The processing station 814 includes a modem 816, a gateway 818, a printer 820, an accounting application 822, a global distribution system display (illustratively Sabre) display terminal 824 and a local area network (LAN) 826. The modem 816 receives information from, and provides information to, the legacy server 808 through the wide area network 810. The modem 816 provides information to, and receives information from, the gateway 818, which may be a server. The gateway 818, the printer 820, the accounting application 822 and the display terminal 824 provide information to, and receive information from, the travel agency local area network 826.

The airlines 802 introduce established and published flight and fare information to the legacy server 808 which stores this information. In like manner, the hotel chains introduce established and published information relating to room availability and room rates to the legacy server 808, and the car rental agencies 806 introduce information relating to car availability and car rates to the legacy server 808. The legacy server 808 stores this information. Whenever requested by the travel agency 812, the legacy server 808 transmits the requested information to the modem 816 in the travel agency processing station 814 through the wide area network 810.

The modem 816 at the processing station 814 introduces the requested information to the gateway 818, which may be a server. The gateway 818 then introduces this information to the local area network 826 which then introduces the information to the appropriate one of the printer 820, the accounting application 822, and the display terminal 824. The printer 820 provides a record of a flight transaction, including the flight number and the flight fare, selected by the agent at the processing station 814. The accounting application 822 provides an accounting at the processing station 814 of the flight transaction selected by the agent. The terminal 824 provides a visual indication on a display screen of information relating to the different flights requested by the agent through the wide area network 810 from the legacy server 808.

It will be appreciated that the discussion above relating to flight information and flight fares applies equally as well to information relating to room availability and room rates when the agent at the processing station 814 requests this information from the legacy server 818 through the wide area network 810. It also applies equally as well to information relating to car availability and car rates when the agent at the processing station 814 requests this information from the legacy server 808 through the wide area network 810.

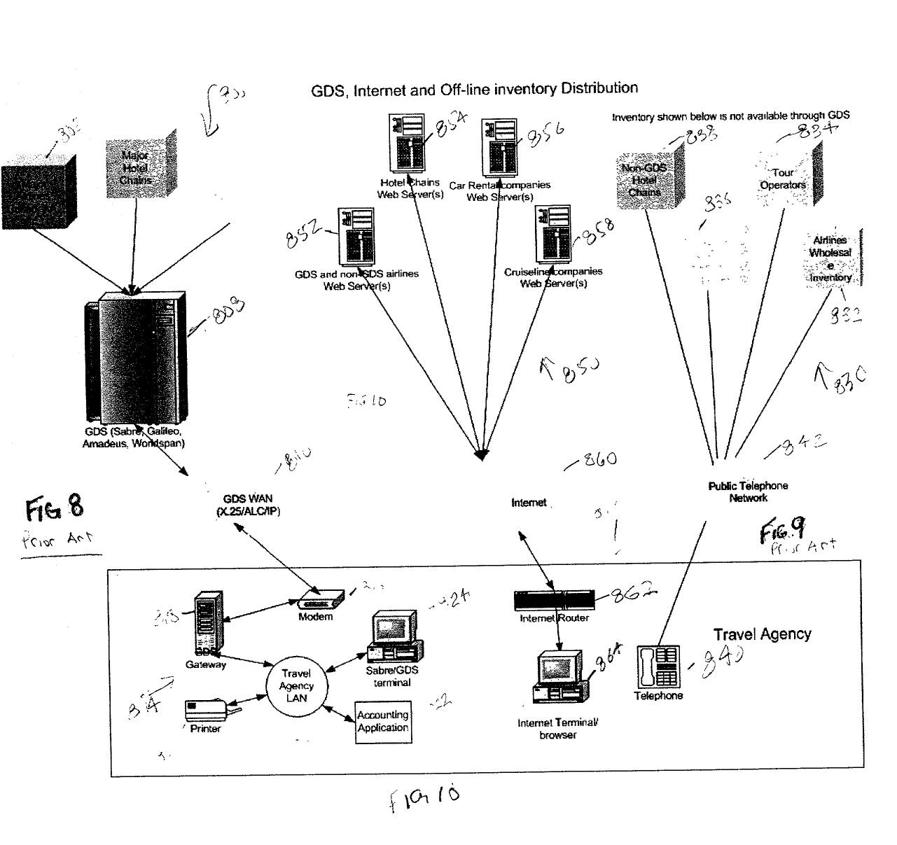

FIG. 9 shows another embodiment, generally indicated at 830, in the prior art. The embodiment 830 includes airline wholesale inventory 832, tour operators 834, non-GDS car rental companies 836 and non-GDS hotel chains 838. The airline wholesale and retail inventory is that not included in the global distribution system (GDS) 808 shown in FIG. 8. It includes airline fares discounted from the established and published fares. The non-GDS hotel chains 838 are those other than the global distribution system hotel chains included in the server 808. The tour operators 834 sponsor tours to different parts of the world and include such operators as Tauck.

The travel agency 812 obtains information from individual ones of the different inventory sources 832, 834, 836 and 838 by instituting a call from a telephone 840 at the travel station. This call passes through a public telephone network 842 to one of the sources 832, 834, 836 and 838. As will be appreciated, this mode of obtaining information is slow. It is also limited in its capabilities because the lines in the telephone network may be busy. Time is also required to connect the travel agent to the proper provider of information at the telephoned one of the sources 822, 834, 836 and 838. This is particularly true in the telephone systems at the sources where computerized machines, and not humans, answer the phone.

FIG. 10 shows an embodiment, generally indicated at 850, of applicants' invention. The embodiment 850 may include web servers 852 of the global distribution system and other airlines not in the global distribution system, web servers 854 of hotel chains, web servers 850 of car rental companies and web servers 858 of cruise line companies. These companies are only illustrative, since web servers from other operational companies may also be included without departing from the scope of the invention. Information from the web servers 852, 854, 856 and 858 is passed through the internet 860 to an internet router 862 in the travel agency 860. The indications from the router 860 pass to an internet display terminal 864 which may include a browser. The system shown in FIG. 10 may also include a gateway corresponding to the gateway 818 in FIG. 8, a travel agency LAN corresponding to the travel agency LAN in FIG. 8, a printer corresponding to the printer 820 in FIG. 8 and an accounting application corresponding to the accounting application 822 in FIG. 8.

As will be seen, requests for information are provided from the travel agency 814 through the internet 860 to the sources 852, 854, 856, and 858. The requests may specify a travel date between an originating position and a destination. Responses to the requests are made through the internet by the sources 852, 854, 856, and 858. The responses may specify the travel date, the originating position, the destination, the time of departure from the starting position and the time of arrival at the destination and may further specify the travel times on the travel date for the flights and the prices for the flights. The responses cause information to be displayed on the display terminal 864. The information displayed for each response may include the airline, the travel date, the city and time of departure, the destination and the time of arrival and the price.

Communication between the travel agency 814 and the sources 852, 854, 856, and 858 through the internet offers certain advantages. One advantage is that the establishment of the communications between the web servers 852, 854, 856, and 858 and the display terminal 864 is provided in a minimal time. Another advantage is that any possibilities of busy lines as in telephone calls are minimized. A further advantage is that the cost to the operators of the web servers is minimized. Another advantage is that the flights specified by the different airlines and meeting the specifications provided by the processing station for the event can be displayed on a single display screen.

Although this invention has been disclosed and illustrated with reference to particular embodiments, the principles involved are susceptible for use in numerous other embodiments which will be apparent to persons of ordinary skill in the art. The invention is, therefore, to be limited only as indicated by the scope of the claims.

What is claimed is:

1. A method of providing at a processing station an indication of a minimal price for an event, including the steps of:
providing prices for the event at the processing station from a plurality of sources including a global distribution system and non-global distribution sources,
providing a display screen, and
providing the prices from the global distribution system and the non-global distribution sources through the internet to the display screen for the display of the prices on the display screen.

2. In a method as set forth in claim 1 wherein
the prices from the global distribution system and the non-global distribution sources pass through an internet router after passing through the internet and before being introduced to the display screen.

3. In a method as set forth in claim 1 wherein
the event is an airline flight on a specified day from a first specified locality to a second specified locality.

4. In a method as set forth in claim 1 wherein
the sources include airlines within the global distribution system and airlines not within the global distribution system.

5. In a method as set forth in claim 3 wherein
the prices from the global distribution system and the non-global distribution sources pass through an internet router after passing through the internet and before being introduced to the display screen and wherein
the sources include airlines within the global distribution system and airlines not within the global distribution system.

6. A method as set forth in claim 2 wherein
the prices are prices of hotel chains.

7. A method as set forth in claim 2 wherein
the prices are prices of car rental companies.

8. A method as set forth in claim 2 wherein
the prices are prices of cruise line companies.

9. A method as set forth in claim 1 wherein
a printer at the processing station prints a ticket selected from the global distribution system and non-global distribution sources for the event.

10. A method as set forth in claim 6 wherein
a printer at the processing station prints a ticket selected from the global distribution system and the non-global distribution sources for the event.

11. A method as set forth in claim 1 wherein
an accounting application at the processing station provides an accounting of the ticket printed at the processing station and selected from the global distribution system and the non-global distribution sources for the event.

12. A method as set forth in claim 10 wherein
an accounting application at the processing station provides an accounting of the ticket printed at the processing station and selected from the global distribution system and the non-global distribution sources for the event.

13. A method as set forth in claim 1 wherein
the global distribution system provides specifics for the event including the flight number, the time of departure from the starting position and the time of arrival at the destination.

14. A method of providing at a processing station an indication of a minimal price for an event, including the steps of:
providing prices for the event from sources including a legacy distribution system and non-legacy distribution sources,
passing the prices for the event from the sources including the legacy distribution system and the non-legacy distribution sources through the internet, and
providing a display on a display screen of the prices passing through the internet from the legacy distribution system and the non-legacy distribution sources for the event.

15. A method as set forth in claim 14 wherein
the prices from the sources including the prices from the legacy distribution system and the non-legacy distribution sources for the event pass through an internet router after passing through the internet and before passing to the display screen.

16. A method as set forth in claim 14 wherein
the special prices are prices of airline tickets on a specified day from an originating location to a destination.

17. A method as set forth in claim 16 wherein
the sources provide air fares selected from the legacy distribution system and the non-legacy distribution sources for the event.

18. A method as set forth in claim 17 wherein
the prices are prices offered by hotel chains.

19. A method as set forth in claim 17 wherein
the prices are prices offered by car rental agencies.

20. A method as set forth in claim 17 wherein
the prices are prices offered by cruise line operators.

21. A method as set forth in claim 18 wherein
the prices from the legacy distribution system and the non-legacy distribution sources for the event pass through an internet router after passing through the internet and before passing to the display screen.

22. A method as set forth in claim 19 wherein
the prices from the legacy distribution system and the non-legacy distribution sources for the event pass through an internet router after passing through the internet and before passing to the display screen.

23. A method as set forth in claim 19 wherein
the prices from the legacy distribution system and the non-legacy distribution sources for the event pass through an internet router after passing through the internet and before passing to the display screen.

24. A method as set forth in claim 14 wherein
a printer at the processing station prints a ticket selected from the legacy distribution system and the non-legacy distribution sources for the event.

25. A method as set forth in claim 17 wherein
a printer at the processing station prints a ticket selected from the legacy distribution system and the non-legacy distribution sources for the event.

26. A method as set forth in claim 14 wherein
an accounting application at the processing station provides an accounting of the ticket printed at the processing station and selected from the legacy distribution system and the non-legacy distribution sources for the event.

27. A method as set forth in claim 25 wherein
an accounting application at the processing station provides an accounting of the ticket printed at the processing station and selected from the legacy distribution system and the non-legacy distribution sources for the event.

28. A method as set forth in claim 26 wherein
an accounting application at the processing station provides an accounting of the ticket printed at the processing station and selected from the legacy distribution system and the non-legacy distribution sources for the event.

29. A method of providing at a processing station an indication of a minimal price for an event, including the steps of:
providing requests from the processing station through the internet to the legacy servers and the non-legacy servers of prices for the event,
providing prices and specifics of the event from the legacy servers and non-legacy servers through the internet to the processing stations, and
displaying on a display screen at the processing station the prices and the specifics from the legacy servers and non-legacy servers for the event.

30. A method as set forth in claim 29 wherein
the prices from the legacy servers and the non-legacy servers pass through an internet router from the internet to the display.

31. A method as set forth in claim 29 wherein
the request from the processing station specified the event and the day of the event and wherein
the specifics from the legacy servers and the non-legacy servers identify the event and specify the time of the event during the specified date and specify the price for the event and wherein
the display shows the specifics set forth by the legacy servers and the non-legacy servers to the display.

32. A method as set forth in claim 29 wherein
the event is an occupancy of a room in a hotel on a particular date and the sources are rooms in hotel chains.

33. A method as set forth in claim 29 wherein
the event is a rental of a car on a particular date and the sources are car rental agencies.

34. A method as set forth in claim 28 wherein
the event is an occupancy of a room in a cruise line on a particular date and the sources are cruise line operators.

35. A method of providing at a processing station an indication of a minimal price for an event, including the steps of:
providing from the processing station to legacy servers and non-legacy servers through the internet a request specifying the day of the event,
providing from the legacy servers and the non-legacy servers through the internet to the processing station information specifying the time of the event during the specified date and specifying the price for the event, and
providing on a display at the processing station the specifics set forth by the legacy servers and the non-legacy servers to the display.

36. A method as set forth in claim 35 wherein
the event is an occupancy of a room in a hotel on a specified date and the sources are hotel chains.

37. A method as set forth in claim 35 wherein
the event is a rental of a car on a specified date and the source is a car rental agency.

38. A method as set forth in claim 35 wherein
the event is an occupancy of a room in a cruise line on a specified date and the sources are cruise line operators.

39. A method of providing at a processing station an indication of a minimal price for an event on a particular date, including the steps of:
providing requests from the processing station through the internet to sources including a global distribution system and non-global distribution sources of prices and specifics for the event,
providing from the sources, including the global distribution system and the non-global distribution sources, through the internet to the processing stations the prices and specifics for the event, and
displaying on a display screen at the processing station the prices and the specifics from the global distribution system and the non-global distribution sources for the event.

40. A method as set forth in claim 37 wherein
the event is a trip on a specified day and the specifics provided for the event by the sources include the time of departure by a carrier during the specified day and the time of arrival of the carrier at the destination and the flight number and the price.

41. In a method of providing at a processing station an indiction of a minimal price for an event, the steps of:
providing through the internet from the processing station to non-legacy servers a request for information concerning the event where the date and specifics of the event are specified,
providing through the internet from non-legacy servers information fulfilling the request and specifying the times on the particular date for the event and specifying the price for the event and specifying the identification of the event by the non-legacy servers to the processing station, and
providing a display at the processing station of the information provided through the internet from the non-legacy servers to the processing station.

42. In a method as set forth in claim 41 wherein
the event is an airplane trip and wherein
the specifics requested by the processing station concerning the event include the date of the trip and the originating position and the destination and wherein
the information provided by the non-legacy sources includes the airline providing the transportation, the date of the event, the originating position, the destination, the time of departure from the starting position, the time of arrival at the destination and the price for the event.
